(19) United States
(12) Patent Application Publication
(10) Pub. No.: US 2006/0145398 A1
(43) Pub. Date: Jul. 6, 2006

(54) Release layer comprising diamond-like carbon (DLC) or doped DLC with tunable composition for imprint lithography templates and contact masks

(75) Inventors: Todd C. Bailey, Fishkill, NY (US); Nicholas A. Stacey, Austin, TX (US); Edward R. Engbrecht, Austin, TX (US); John G. Ekerdt, Austin, TX (US)

Correspondence Address: Kelly K. Kordzik;Winstead Sechrest and Minick P.C., P.O. Box 50784, Dallas, TX, 75201, US

(73) Assignee: Board of Regents, The University of Texas System

(21) Appl. No.: 11/027,473

(22) Filed: Dec. 30, 2004

(51) Int. Cl. B29C 33/60

(52) U.S. Cl. 264/338

(57) ABSTRACT

The present invention pertains to disposing a diamond-like composition on a template, wherein the diamond-like composition acts as a release layer. The diamond-like composition is substantially transparent to actinic radiation, e.g., ultraviolet (UV) light, and will also have a desired surface energy, wherein the desired surface energy minimizes adhesion between the template and an underlying material disposed on a substrate. The diamond-like composition is characterized with a low surface energy that exhibits desirable release characteristics.

### BACKGROUND OF THE INVENTION

The field of the invention relates generally to micro-fabrication of structures. More particularly, the present invention is directed to the production of a template having improved release properties.

Micro-fabrication involves the fabrication of very small structures, e.g., having features on the order of micro-meters or smaller. One area in which micro-fabrication has had a sizeable impact is in the processing of integrated circuits. As the semiconductor processing industry continues to strive for higher production yields while increasing circuit densities, micro-fabrication becomes increasingly important. Micro-fabrication provides greater process control while allowing reductions in the minimum feature dimension of the structures formed.

Optical lithography techniques are currently used in micro-fabrication. However, these methods are potentially reaching their limits in resolution. Sub-micron scale lithography has been a crucial process in the microelectronics industry. The use of sub-micron scale lithography allows manufacturers to meet the increased demand for smaller and more densely packed electronic components on chips.

An exemplary micro-fabrication technique is shown in U.S. Pat. No. 6,334,960 to Willson et al. [hereinafter referred to as Willson]. Willson discloses a method of forming a relief image in a structure. The method includes providing a substrate having a transfer layer. The transfer layer is covered with a polymerizable fluid composition. A template makes mechanical contact with the polymerizable fluid. The template includes a relief structure, and the polymerizable fluid composition fills the relief structure. The polymerizable fluid composition is then subjected to conditions to solidify and polymerize the same, forming a solidified polymeric material on the transfer layer that contains a relief structure complimentary to that of the template. The template is then separated from the solid polymeric material such that a replica of the relief structure in the template is formed in the solidified polymeric material. The transfer layer and the solidified polymeric material are subjected to an environment to selectively etch the transfer layer relative to the solidified polymeric material such that a relief image is formed in the transfer layer. To minimize adhesion between the solidified polymeric material and the template, a release layer is disposed on the template. The release layer functions to provide a low energy surface to enhance template release, thereby minimizing distortions in the pattern due, inter alia, to removal of the template from the solidified polymeric material.

Thus, a need exists to provide a template with improved release properties.

### SUMMARY OF THE INVENTION

The present invention pertains to disposing a conformal diamond-like composition on a patterned template, wherein the diamond-like composition acts as a release layer. The diamond-like composition is deposited so that the release layer is substantially transparent to actinic radiation, e.g., ultraviolet (UV) light, and will also have a desired characteristics, i.e., characterized with a low surface energy that exhibits desirable release properties. Specifically, the low surface energy of the diamond-like composition minimizes the adhesion to the template material compressed between the template and a substrate upon which the imprinting material is disposed. As a result, the material is more likely to adhere to the substrate than to adhere to the template. By reducing the adhesion of the material to the substrate, the quality of the features defined in the material is improved. In addition, the thickness of the diamond-like composition should be established so as to not substantially reduce the critical dimensions of the features of the template. The diamond-like composition may also be doped with a metallic species to allow discharge of electrons. These and other embodiments are described in further detail below.

### BRIEF DESCRIPTION OF THE DRAWINGS

FIG. 1 is a simplified elevation view of a lithographic system in accordance with the present invention;

FIG. 2 is a simplified elevation view of a template spaced-apart from the imprinting layer, shown in FIG. 2, after patterning of the imprinting layer; and

FIG. 3 is a cross-sectional view of the template shown in FIG. 2 with a release layer being disposed thereon.

### DETAILED DESCRIPTION OF THE INVENTION

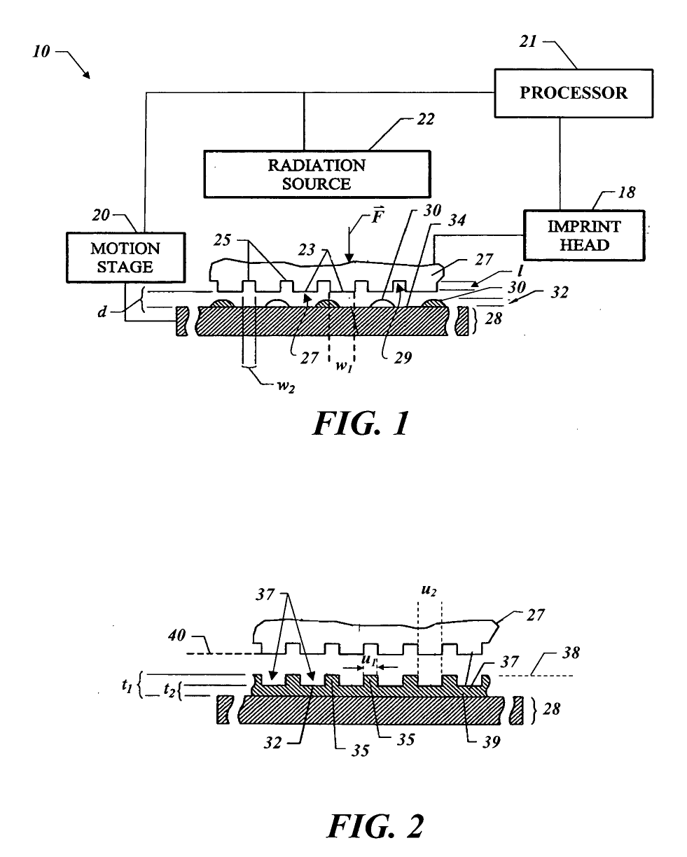

FIG. 1 depicts a plan view of lithographic system 10 in accordance with one embodiment of the present invention that includes a radiation source 22 coupled to impinge actinic radiation upon a substrate 28 coupled to a motion stage. A template 27 is coupled to an imprint head 18 to be disposed between substrate 28 and radiation source 22. Motion stage 20, radiation source 22 and imprint head operate under control of a processor 21 and are in electrical communication therewith.

Referring to both FIGS. 1 and 2, template 27 includes a plurality of features defined by a plurality of spaced-apart protrusions 23 having a width w₁ and recesses 25 having a width w₂. Widths w₁ and w₂, may be the same or different, depending upon the application. A step, defined between an apex surface 27 of protrusions 23 and a nadir surface 29 of recesses 25 has a length l, on the order of nanometers, e.g., 30 nanometers. The plurality of features defines an original pattern that forms the basis of a desired pattern to be transferred into substrate 28. Typically the desired pattern is an inverse of the original pattern and is formed by formation of a recorded pattern on substrate 28 by contacting a flowable region with template 27. To that end, imprint head 18 is adapted to move along the Z-axis and vary a distance “d” between template 27 and substrate 28. In this manner, the features on template 27 may be imprinted into a conformable region of substrate 28, discussed more fully below. The relative dimensions of the features in the original pattern define the relative dimensions of the features in the recorded pattern, and therefore, in the desired pattern.

A conformable region, such as an imprinting layer 32, is disposed on a portion of a surface 34 that presents a substantially smooth, if not planar, profile. It should be understood that the conformable region may be formed using any known technique to produce conformable material, such as a hot embossing process disclosed in U.S. Pat. No. 5,772,905 to Chou, which is incorporated by reference in its entirety herein, or a laser assisted direct imprinting (LADI) process of the type described by Chou et al. in “Ultrafast and Direct Imprint of Nanostructures in Silicon”, Nature, Col. 447, pp. 835-837, June 4602, which is incorporated by reference in its entirety herein. In the present embodiment, however, the conformable region consists of imprinting layer 32 being deposited as a plurality of spaced-apart discrete droplets 30 of an imprinting material. Imprinting layer 32 is formed from imprinting material that may be selectively polymerized and cross-linked to record the original pattern therein, defining a recorded pattern.

The recorded pattern 39 is produced, in part, by mechanical contact between imprinting layer 32 and template 27. To that end, imprint head 18 reduces the distance “d” to allow imprinting layer 32 to come into mechanical contact with template 27, spreading droplets 30 so as to form a contiguous formation of imprinting material over surface 34. In one embodiment, distance “d” is reduced to allow recesses 25 to be filled with imprinting material.

To facilitate filling of recesses 25, the imprinting material is provided with the requisite properties to completely fill recesses 25 while covering surface 34 with a contiguous formation of the imprinting material. An exemplary imprinting material and imprint lithography process is disclosed in U.S. Pat. No. 6,696,220, entitled TEMPLATE FOR ROOM TEMPERATURE, LOW PRESSURE MICRO-AND NANO-IMPRINT LITHOGRAPHY, as well as, U.S. patent application Ser. Nos. 09/920,341, filed Aug. 1, 2001, entitled METHODS FOR HIGH-PRECISION GAP AND ORIENTATION SENSING BETWEEN A TRANSPARENT TEMPLATE AND SUBSTRATE FOR IMPRINT LITHOGRAPHY, 09/908,455, filed Feb. 12, 2002, entitled METHOD AND SYSTEM OF AUTOMATIC FLUID DISPENSING FOR IMPRINT LITHOGRAPHY PROCESSES, 09/907,512, filed Jul. 16, 2001, entitled HIGH-RESOLUTION OVERLAY ALIGNMENT METHODS AND SYSTEMS FOR IMPRINT LITHOGRAPHY all of which are assigned to assignee of the present invention and incorporated by reference herein.

After a desired distance “d” has been reached, radiation source 22 produces actinic radiation that polymerizes and cross-links the imprinting material, forming recorded pattern 39 as cross-linked and polymerized imprinting material. As a result, the composition of imprinting layer transforms from a flowable imprinting material to a solidified material. Specifically, recorded pattern 39 is formed from the cross-linked and polymerized material to provide a side thereof with a shape conforming to a shape of a surface 40 of template 27. In this manner, recorded pattern 39 includes recessions 37 in superimposition with protrusions 23 and projections 35 in superimposition with recesses 25 after the desired, usually minimum distance “d”, has been reached, leaving projections 35 with a thickness t₁, and recessions 37 with a thickness t₂. Thicknesses “t₁” and “t₂” may be any thickness desired, dependent upon the application. The width u₁ of projections 35 is defined by width w₁, and the width u₂ of recessions 37 is defined by the width w₂.

After formation of recorded pattern 39 distance “d” is increased so that template 27 and recorded pattern 39 are spaced-apart. Additional processing may be employed to complete the patterning of substrate 28. For example, substrate 28 and imprinting layer 32 may be etched to transfer the pattern of imprinting layer 32 into substrate 28, providing a patterned surface (not shown). To facilitate etching, the material from which imprinting layer 32 is formed may be varied to define a relative etch rate with respect to substrate 28, as desired.

To that end, imprinting layer 32 may be provided with an etch differential with respect to standard photo-resist material (not shown), e.g., PMMA, selectively disposed thereon. The photo-resist material (not shown) may be provided to further pattern imprinting layer 32, using known techniques. Any etch process may be employed, dependent upon the etch rate desired and the underlying constituents that form substrate 28 and imprinting layer 32. An exemplary radiation source 22 may produce ultraviolet radiation; however, any known radiation source may be employed. The selection of radiation employed to initiate the polymerization of the material in imprinting layer 32 is known to one skilled in the art and typically depends on the specific application and materials desired.

Referring to FIGS. 1 and 2, the pattern produced by the present patterning technique may be transferred into substrate 28 to provide features having aspect ratios as great as 30:1. To that end, one embodiment of template 27 has recesses 25 defining an aspect ratio in a range of 1:1 to 10:1. Specifically, protrusions 23 have a width w₁ in a range of about 10 nm to about 5000 μm, and recesses 25 have a width w₂ in a range of 10 nm to about 5000 μm. As a result, template 27 may be formed from various conventional materials, including, but not limited to, fused-silica, quartz, silicon, organic polymers, siloxane polymers, borosilicate glass, fluorocarbon polymers, metal, hardened sapphire and the like.

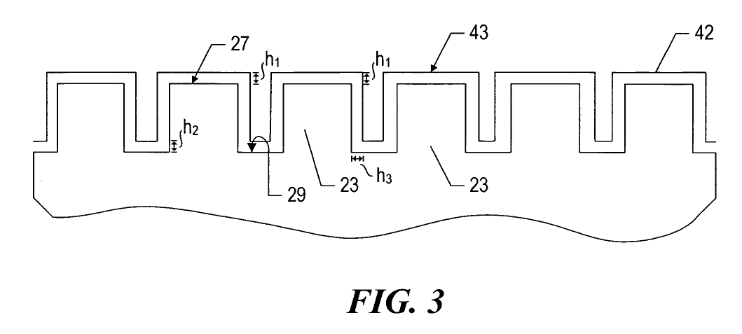

Referring to FIGS. 2 and 3, a desired characteristic of template 27 is that the adherence of cross-linked polymer material thereto is minimized. To that end, a surface of template 27 may be treated with a modifying agent, referred to as a release layer 42. To function satisfactorily, it is desired that release layer 42 should adhere well to template 27 without adhering well to recorded pattern 39, should be relatively transparent to actinic radiation, as well as mechanically sound to minimize premature operational failure. This has been commonly achieved in nanoimprint lithography through the use of, for example, self-assembled monomers (F-SAMS). However, such monolayer coatings are not mechanically robust and can easily be removed through physical contact and microabrasion. Materials embodied in the present Invention for use as release layer 42 are referred to as diamond-like compositions. Diamond-like carbon films, commonly referred to as “DLC” films, are coatings that have generally similar properties as polycrystalline diamond coatings, such as low surface friction, low surface energy and high hardness, but unlike diamond coatings, diamond-like carbon coatings are amorphous rather than crystalline. Naturally occurring crystalline diamond is formed from a network of sp³ carbon orbitals, arranged in a local tetrahedral symmetry, maintaining long range crystalline order. However, DLC films have a random mixture of tetrahedral sp³ and hexagonal sp² carbon orbitals, with no detectable long range order. In general, two known categories of diamond-like, amorphous carbon films can be deposited, depending on the origin of the carbon source and deposition process; hydrogenated and non-hydrogenated DLC films. The level of hydrogen and the ratio of sp³/sp² bonds control many of the optical and hardness properties of the material and these in turn can be tailored by choice of starting materials and deposition conditions. In addition to carbon and hydrogen, diamond-like compositions can be widely modified in their properties by the inclusion of different atomic species into the coating through addition of feed chemicals containing these atoms. The inclusion of such atom can modify film properties such as conductivity, absorbance, strength and surface energy. Such atoms can include, without limitation, silicon fluorine, boron and metals.

Examples of diamond like coating compositions are available under the tradename DYLYN® from The Bekaert Group, Amherst, N.Y., and as “diamond-like glass” (DLG), examples of which are disclosed in U.S. Pat. No. 6,696,157. For the purpose of this invention, diamond-like compositions are characterized by low surface energy material that exhibit excellent release characteristics to cross-linked polymer material 36. Specifically, surface energies associated with the diamond-like compositions is in a range of 25 to 40 mN/m (milli-Newtons per meter The low surface energies associated with these diamond-like compositions minimize the adhesion of cross-linked polymer material 36 to template 27. As a result, cross-linked polymer material 36 of imprinting layer 32 is less likely to tear or shear during separation of template 27 from cross-linked polymer material 36 in imprinting layer 32.

Release layer 42 is also substantially transparent to actinic radiation, e.g., UV light, such as that emmitted from a mercury or mercury-xenon arc source. Transparency of release layer 42, as well as template 27, to actinic radiation is desired in imprint lithography. Without actinic radiation propagating through both release layer 42 and template 27, solidification and cross-linking of imprinting material would be problematic. To that end, release layer 42 should not have a thicknesses, h₁ and h₂ that would prevent sufficient actinic radiation from propagating therethrough to impinge upon the imprinting material. Thickness h₁ is measured between exposed surface 43 of release layer 42 and apex surface 27. Thickness h₂ is measured between exposed surface 43 of release layer 42 and nadir surface 29. In the present embodiment, release layer is no greater than 500 nm thick. Typically, the diamond-like amorphous release layer is formed upon the surface 40 of template 27 after being patterned. This has many benefits, such as, low surface energy, diamond-like hardness and ease of application. To that end, the thickness of the conformal release layer is typically minimized to ensure critical feature dimensions present on template 27 are not unduly modified, and/or lost, but should be thick enough to ensure a pin-hole free coating. For example, the differential thickness t₁-t₂ will be substantially unchanged should h₁ and h₂ be substantially equal. However, the dimensions u₁ and u₂ may be modified by release layer 42. Specifically, the dimensions of u₁ would be augmented by 2h₃, where h₃ is a thickness of release layer 42 measured from exposed surface 42 to one of the sidewalls of projections 23. Conversely, the dimensions of u₂ would be reduced by the same amount. One manner in which to attenuate changes in dimensions of recorded pattern due to the presence of release layer 42 is to minimize the thickness h₃, thereof. Usually thickness h₃, h₂ and h₁ are substantially equal. Typically this minimum thickness is of the order of 5 nm. The release layer may be deposited onto template 26 employing any known deposition technique that provide the desired conformality, such as chemical vapor deposition (CVD), plasma vapor deposition (PVD), atomic layer deposition (ALD) and the like. However, the minimum reduction in u₂ is dependent upon the minimum thickness h₃, which may be difficult to achieve while ensuring a pin-hole free coating of release layer 42 to provide desired release characteristics.

Another manner in which to apply release layer 42 while minimizing, if not preventing deviations from the dimensions in the desired pattern, is to produce the original pattern with dimensions that differ from the dimensions in the desired pattern. Specifically, the dimensions in the original pattern may be established to compensate for the dimensional variations that the original pattern undergoes as a result of the application of release layer 42. In this manner, dimensions of the original pattern with release layer 42 disposed thereon could be established to be equal to the dimensions of the desired pattern. For example, to ensure that the desired pattern has the requisite dimensions, u₂ and u₁, dimension w₂ in original pattern may be established as follows:
w₁32 u₁+2h₃ (1)

Similarly, the dimension w₁ may be established as follows:
w₁=u₂−2h₃. (2)
Upon application of release layer 42 having a thickness h₃, w₁ and w₂ would have dimensions equal to the desired dimensions u₁ and u₂, respectively.

In a further embodiment, release layer 42 may be doped with conductive materials to facilitate electrical discharge during e-beam lithography and scanning electron microscope inspection. Doping may include metals or other elements. Alternatively, electrically conductive material (not shown) may be applied adjacent to release layer 42 so that release layer 42 is disposed between the electrically conductive material and body 41.

While this invention has been described with references to various illustrative embodiments, the description is not intended to be construed in a limiting sense. Various modifications and combinations of the illustrative embodiments, as well as other embodiments of the invention, will be apparent to persons skilled in the art upon reference to the description. It is, therefore, intended that the appended claims encompass any such modifications or embodiments.

What is claimed is:

1. A method of varying release properties of a template having a surface, said method comprising:
disposing a diamond-like composition on said patterned surface, with said diamond-like composition having properties to provide a substantially uniform thickness over said patterned surface while maintaining critical features dimension of features formed in said patterned surface and avoiding pin-holes.

2. The method as recited in claim 1 wherein disposing further includes disposing said diamond-like composition from a set of diamond-like compositions consisting of including diamond-like carbon (DLC) and diamond-like nano-composites.

3. The method as recited in claim 2 wherein said nano-composites includes components selected from a set of components consisting essentially of carbon, hydrogen, fluorine, silicon and boron.

4. The method as recited in claim 1 wherein disposed further includes forming said diamond-like composition to be substantially transmissive to UV radiation.

5. The method as recited in claim 1 further including doping said diamond-like composition with electrically conductive elements.

6. The method as recited in claim 1 further including forming said template with a pattern.

7. A method of varying release properties of a template having a patterned surface, said method comprising:
disposing a diamond-like composition on said patterned surface, with said diamond-like composition having properties to provide a substantially uniform thickness over said patterned surface while maintaining critical features dimension of features formed in said patterned surface and being substantially transmissive to a predetermined wavelength of radiation.

8. The method as recited in claim 7 wherein disposing further includes disposing said diamond-like composition from a set of diamond-like carbon (DLC) and diamond-like nano-composites.

9. The method as recited in claim 8 wherein said nano-composites includes DYLYN®.

10. The method as recited in claim 7 wherein said predetermined wavelength includes UV light.

11. The method as recited in claim 7 further including doping said diamond-like composition with electrically conductive elements.

12. The method as recited in claim 7 further including forming said template from a fused-silica.

13. A method of varying release properties of a template having a patterned surface, said method comprising:
forming said template from fused-silica;
disposing a diamond-like composition on said patterned surface, with said diamond-like composition having properties to provide a substantially pin-hole free layer over said patterned surface while maintaining critical features dimension of features formed in said patterned surface and being substantially transmissive to UV radiation.

14. The method as recited in claim 13 wherein disposing further includes disposing said diamond-like composition from a set of diamond-like carbon (DLC) and diamond-like nano-composites.

15. The method as recited in claim 14 wherein said nano-composites includes components selected from a set of components consisting essentially of carbon, hydrogen, fluorine, silicon and boron.

16. The method as recited in claim 14 further including doping said diamond-like composition with electrically conductive elements.
